(19) United States
(12) Patent Application Publication
(10) Pub. No.: US 2026/0113716 A1
(43) Pub. Date: Apr. 23, 2026

(54) SYNCHRONIZATION SIGNAL BLOCK STRUCTURES FOR EXTREMELY LARGE-SCALE MULTIPLE-INPUT-MULTIPLE-OUTPUT CONFIGURATIONS

(71) Applicant: Lenovo (United States) Inc., Morrisville, NC (US)

(72) Inventors: Karthikeyan GANESAN, Nauheim (DE); Ali Ramadan ALl, Kraiburg am Inn (DE); Ravi KUCHIBHOTLA, Chicago, IL (US)

(21) Appl. No.: 18/920,443

(22) Filed: Oct. 18, 2024

(51) Int. Cl. H04W 56/00; H04B 7/0413; H04B 7/06; H04W 74/0833

(52) U.S. Cl. CPC H04W 56/001; H04B 7/0413; H04B 7/06952; H04W 74/0833

(57) ABSTRACT

Various aspects of the present disclosure relate to a synchronization signal block (SSB) design and/or structure for extremely large-scale multiple-input-multiple-output (XL MIMO) configurations. The SSB design accommodates large numbers of SSBs (e.g., 256 SSBs) being associated with a cell (or cell area), supporting an increase of the number SSB beams utilized to cover a cell area during various operations (e.g., cell access procedures, such as RACH procedures).

### TECHNICAL FIELD

The present disclosure relates to wireless communications, and more specifically to synchronization signal block (SSB) structures for extremely large-scale multiple-input-multiple-output (XL MIMO) configurations.

### BACKGROUND

A wireless communications system may include one or multiple network communication devices, such as base stations, which may support wireless communications for one or multiple user communication devices, which may be otherwise known as user equipment (UE), or other suitable terminology. The wireless communications system may support wireless communications with one or multiple user communication devices by utilizing resources of the wireless communications system (e.g., time resources (e.g., symbols, slots, subframes, frames, or the like) or frequency resources (e.g., subcarriers, carriers, or the like). Additionally, the wireless communications system may support wireless communications across various radio access technologies including third generation (3G) radio access technology, fourth generation (4G) radio access technology, fifth generation (5G) radio access technology, among other suitable radio access technologies beyond 5G (e.g., sixth generation (6G)).

The wireless communications system may support XL MIMO technologies, such as large-scale deployments (1000+) of antenna elements, which can improve the capacity of the network, data rates, and spectral efficiency. For example, 6G radio access technology may include an antenna element configuration of 5000 or more antenna elements in an upper mid-band frequency (e.g., 7 to 24 GHz).

### SUMMARY

An article “a” before an element is unrestricted and understood to refer to “at least one” of those elements or “one or more” of those elements. The terms “a,” “at least one,” “one or more,” and “at least one of one or more” may be interchangeable. As used herein, including in the claims, “or” as used in a list of items (e.g., a list of items prefaced by a phrase such as “at least one of” or “one or more of” or “one or both of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on. Further, as used herein, including in the claims, a “set” may include one or more elements.

The present disclosure relates to methods, apparatuses, and systems that enable a network to provide and/or utilize SSB structures for XL MIMO configurations.

Some implementations of the method and apparatuses described herein may further include a network entity for wireless communication, comprising at least one memory, and at least one processor coupled with the at least one memory and configured to cause the network entity to configure multiple SSB burst size values based on a frequency range for a cell area, subcarrier spacings (SCSs) for the cell area, and a maximum number of supported SSB beams based on an XL MIMO configuration of an antenna array for the cell area and transmit a number of SSBs covering the cell area within an SSB burst transmission duration that is based on the configured multiple SSB burst size values.

In some implementations of the method and apparatuses described herein, the maximum number of supported SSB beams is based on a number of antenna elements within the XL MIMO configuration of the cell area.

In some implementations of the method and apparatuses described herein, the at least one processor is configured to cause the network entity to segment the SSB burst transmission duration with multiple SSB bursts associated with the multiple SSB burst size values, insert a time gap between adjacent SSB bursts of the multiple SSB bursts, and transmit the number of SSBs covering the cell area using the multiple SSB bursts.

In some implementations of the method and apparatuses described herein, the at least one processor is configured to cause the network entity to transmit the number of SSBs contiguously via beam sweeping over the cell area based on the configured multiple SSB burst size values.

In some implementations of the method and apparatuses described herein, the at least one processor is further configured to cause the network entity to transmit a master information block (MIB) indicating multiple radio frames that map the number of SSBs.

In some implementations of the method and apparatuses described herein, the at least one processor is configured to cause the network entity to transmit the number of SSBs within symbols of a slot of a radio frame located after a control resource set (CORESET) allocated to an initial symbol of the slot.

In some implementations of the method and apparatuses described herein, the at least one processor is configured to cause the network entity to transmit the number of SSBs within symbols of a slot of a radio frame located after a CORESET allocated to two initial symbols of the slot.

In some implementations of the method and apparatuses described herein, the at least one processor is further configured to cause the network entity to transmit the number of SSBs based on the configured multiple SSB burst size values, by segmenting the SSB burst transmission duration into smaller SSB burst sizes and transmitting the number of SSBs via the smaller SSB burst sizes.

In some implementations of the method and apparatuses described herein, the at least one processor is further configured to cause the network entity to segment the SSB burst transmission duration in a time domain and non-contiguously transmit the SSBs via the smaller SSB burst sizes.

In some implementations of the method and apparatuses described herein, each of the smaller SSB burst sizes corresponds to a portion of the cell area.

In some implementations of the method and apparatuses described herein, a quantity of the smaller SSB burst sizes is based on the frequency range for the cell area, the SCSs for the cell area, and the maximum number of supported SSB beams for the cell area.

In some implementations of the method and apparatuses described herein, the at least one processor is further configured to cause the network entity to transmit a system information block (SIB) having an information element that indicates a candidate SSB burst index transmission for the configured multiple SSB burst size values.

Some implementations of the method and apparatuses described herein may further include a method performed by a network entity, the method comprising configuring multiple SSB burst size values based on a frequency range for a cell area, SCSs for the cell area, and a maximum number of supported SSB beams based on an XL MIMO configuration of an antenna array for the cell area and transmitting a number of SSBs covering the cell area within an SSB burst transmission duration that is based on the configured multiple SSB burst size values.

In some implementations of the method and apparatuses described herein, the maximum number of supported SSB beams is based on a number of antenna elements within the XL MIMO configuration of the cell area.

Some implementations of the method and apparatuses described herein may further include a network entity for wireless communication, comprising at least one memory and at least one processor coupled with the at least one memory and configured to cause the network entity to map an SSB burst index to a random access channel (RACH) occasion set, and signal the mapping to one or more UEs within a cell area.

In some implementations of the method and apparatuses described herein, the mapping includes a mapping of SSB blocks within SSB bursts associated with the SSB burst index to RACH occasions of the RACH occasion set.

In some implementations of the method and apparatuses described herein, the mapping includes a frequency division multiplexed mapping of an ascending order of RACH occasions of the RACH occasion set to an ascending order of SSB bursts associated with the SSB burst index.

In some implementations of the method and apparatuses described herein, the mapping includes a mapping of SSB bursts associated with the SSB burst index and RACH occasions of the RACH occasion set that are code division multiplexed in time and frequency resources.

In some implementations of the method and apparatuses described herein, the at least one processor is further configured to cause the network entity to assign a maximum time for selection of a RACH occasion mapped to a SSB burst associated with the SSB burst index.

Some implementations of the method and apparatuses described herein may further include a method performed by a network entity, the method comprising mapping an SSB burst index to a RACH occasion set and signaling the mapping to one or more user equipment (UEs) within a cell area.

### BRIEF DESCRIPTION OF THE DRAWINGS

FIG. 1 illustrates an example of a wireless communications system in accordance with aspects of the present disclosure.

FIG. 2 illustrates an example mapping between SSBs and a CORESET in accordance with aspects of the present disclosure.

FIG. 3 illustrates another example mapping between SSBs and a CORESET in accordance with aspects of the present disclosure.

FIG. 4 illustrates an example of a non-contiguous SSB transmission in accordance with aspects of the present disclosure.

FIGS. 5A-5B illustrate example mappings of SSB bursts to RACH occasions in accordance with aspects of the present disclosure.

FIG. 6 illustrates an example of a UE in accordance with aspects of the present disclosure.

FIG. 7 illustrates an example of a processor in accordance with aspects of the present disclosure.

FIG. 8 illustrates an example of a network equipment (NE) in accordance with aspects of the present disclosure.

FIG. 9 illustrates a flowchart of a method performed by an NE in accordance with aspects of the present disclosure.

FIG. 10 illustrates a flowchart of a method performed by an NE in accordance with aspects of the present disclosure.

### DETAILED DESCRIPTION

During cell search operations, a UE receives and utilizes synchronization signals from a cell (e.g., a base station) to determine information that enables the UE to access the cell. For example, the cell may transmit SSBs every 5 milliseconds or with other periodicities (e.g., 5 ms, 10 ms, 20 ms, and so on). To provide for coverage over an entire cell area, the cell may perform beam sweeping. Beam sweeping entails communication of one or more cell defining SSB bursts (or burst sets), where each SSB burst includes a set of SSBs, and where each SSB may be transmitted by a different or separate beam.

For 5G (new radio, or NR) wireless access technologies, the SSB burst size is 5 ms (e.g., half of a radio frame), where the SSBs are transmitted in a first half or a second half of a radio frame. Based on the frequency range and subcarrier spacings of the cell, the maximum candidate SSBs is 64, which can be accommodated by 5 ms SSB burst sizes.

However, radio access technologies that deploy an XL MIMO configuration (e.g., a 6G network having a configuration of 1024 antenna elements and 256 transceiver units, or TxRUs) cannot utilize 5 ms SSB burst sizes. Such configurations support a large number of SSBs in the upper mid band frequencies, which increases latency and prevents use of the shorter SSB burst sizes.

The systems and methods described herein introduce an SSB design and/or structure for XL MIMO configurations. The SSB design accommodates a large number of SSBs (e.g., 256 SSBs) being associated with a cell (or cell area), thereby supporting an increase in the number SSB beams utilized to cover a cell area during various operations (e.g., cell access procedures, such as RACH procedures).

For example, the SSB design may include a variable SSB burst size when transmitting SSBs that is based on MIMO configurations, SCSs, and/or frequency ranges. Further, the SSB design enables larger numbers of SSBs to be transmitted within an SSB transmission window (or window duration), as well as the mapping of SSB bursts to RACH occasions. Thus, the SSB design for XL MIMO configurations enables the deployment of XL MIMO configurations by a network without realizing issues associated with SSB structures having incompatible SSB burst sizes, among other benefits.

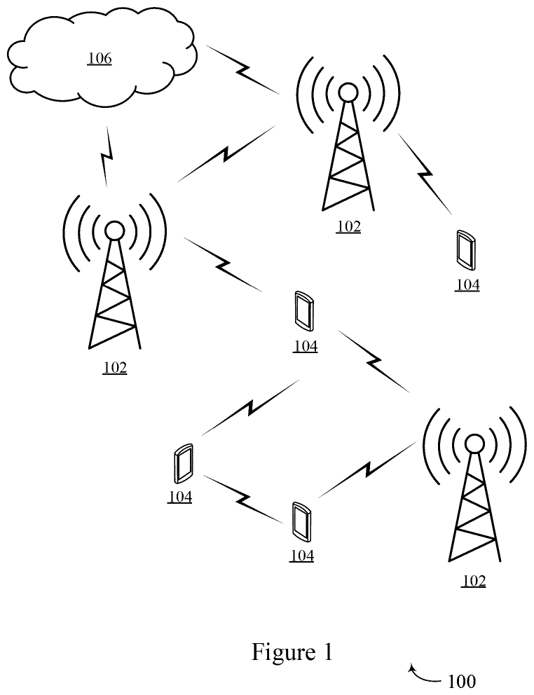

FIG. 1 illustrates an example of a wireless communications system 100 in accordance with aspects of the present disclosure. The wireless communications system 100 may include one or more NE 102, one or more UE 104, and a core network (CN) 106. The wireless communications system 100 may support various radio access technologies. In some implementations, the wireless communications system 100 may be a 4G network, such as an LTE network or an LTE-Advanced (LTE-A) network. In some other implementations, the wireless communications system 100 may be a NR network, such as a 5G network, a 5G-Advanced (5G-A) network, or a 5G ultrawideband (5G-UWB) network. In other implementations, the wireless communications system 100 may be a combination of a 4G network and a 5G network, or other suitable radio access technology including Institute of Electrical and Electronics Engineers (IEEE) 802.11 (Wi-Fi), IEEE 802.16 (WiMAX), IEEE 802.20. The wireless communications system 100 may support radio access technologies beyond 5G, for example, 6G. Additionally, the wireless communications system 100 may support technologies, such as time division multiple access (TDMA), frequency division multiple access (FDMA), or code division multiple access (CDMA), etc.

The one or more NE 102 may be dispersed throughout a geographic region to form the wireless communications system 100. One or more of the NE 102 described herein may be or include or may be referred to as a network node, a base station, a network element, a network function, a network entity, a radio access network (RAN), a NodeB, an eNodeB (eNB), a next-generation NodeB (gNB), or other suitable terminology. An NE 102 and a UE 104 may communicate via a communication link, which may be a wireless or wired connection. For example, an NE 102 and a UE 104 may perform wireless communication (e.g., receive signaling, transmit signaling) over a Uu interface.

An NE 102 may provide a geographic coverage area for which the NE 102 may support services for one or more UEs 104 within the geographic coverage area. For example, an NE 102 and a UE 104 may support wireless communication of signals related to services (e.g., voice, video, packet data, messaging, broadcast, etc.) according to one or multiple radio access technologies. In some implementations, an NE 102 may be moveable, for example, a satellite associated with a non-terrestrial network (NTN). In some implementations, different geographic coverage areas associated with the same or different radio access technologies may overlap, but the different geographic coverage areas may be associated with different NE 102.

The one or more UE 104 may be dispersed throughout a geographic region of the wireless communications system 100. A UE 104 may include or may be referred to as a remote unit, a mobile device, a wireless device, a remote device, a subscriber device, a transmitter device, a receiver device, or some other suitable terminology. In some implementations, the UE 104 may be referred to as a unit, a station, a terminal, or a client, among other examples. Additionally, or alternatively, the UE 104 may be referred to as an Internet-of-Things (IoT) device, an Internet-of-Everything (IoE) device, or machine-type communication (MTC) device, among other examples.

A UE 104 may be able to support wireless communication directly with other UEs 104 over a communication link. For example, a UE 104 may support wireless communication directly with another UE 104 over a device-to-device (D2D) communication link. In some implementations, such as vehicle-to-vehicle (V2V) deployments, vehicle-to-everything (V2X) deployments, or cellular-V2X deployments, the communication link may be referred to as a sidelink. For example, a UE 104 may support wireless communication directly with another UE 104 over a PC5 interface.

An NE 102 may support communications with the CN 106, or with another NE 102, or both. For example, an NE 102 may interface with other NE 102 or the CN 106 through one or more backhaul links (e.g., S1, N2, N2, or network interface). In some implementations, the NE 102 may communicate with each other directly. In some other implementations, the NE 102 may communicate with each other or indirectly (e.g., via the CN 106. In some implementations, one or more NE 102 may include subcomponents, such as an access network entity, which may be an example of an access node controller (ANC). An ANC may communicate with the one or more UEs 104 through one or more other access network transmission entities, which may be referred to as a radio heads, smart radio heads, or transmission-reception points (TRPs).

The CN 106 may support user authentication, access authorization, tracking, connectivity, and other access, routing, or mobility functions. The CN 106 may be an evolved packet core (EPC), or a 5G core (5GC), which may include a control plane entity that manages access and mobility (e.g., a mobility management entity (MME), an access and mobility management functions (AMF)) and a user plane entity that routes packets or interconnects to external networks (e.g., a serving gateway (S-GW), a Packet Data Network (PDN) gateway (P-GW), or a user plane function (UPF)). In some implementations, the control plane entity may manage non-access stratum (NAS) functions, such as mobility, authentication, and bearer management (e.g., data bearers, signal bearers, etc.) for the one or more UEs 104 served by the one or more NE 102 associated with the CN 106.

The CN 106 may communicate with a packet data network over one or more backhaul links (e.g., via an S1, N2, N2, or another network interface). The packet data network may include an application server. In some implementations, one or more UEs 104 may communicate with the application server. A UE 104 may establish a session (e.g., a protocol data unit (PDU) session, or the like) with the CN 106 via an NE 102. The CN 106 may route traffic (e.g., control information, data, and the like) between the UE 104 and the application server using the established session (e.g., the established PDU session). The PDU session may be an example of a logical connection between the UE 104 and the CN 106 (e.g., one or more network functions of the CN 106).

In the wireless communications system 100, the NEs 102 and the UEs 104 may use resources of the wireless communications system 100 (e.g., time resources (e.g., symbols, slots, subframes, frames, or the like) or frequency resources (e.g., subcarriers, carriers)) to perform various operations (e.g., wireless communications). In some implementations, the NEs 102 and the UEs 104 may support different resource structures. For example, the NEs 102 and the UEs 104 may support different frame structures. In some implementations, such as in 4G, the NEs 102 and the UEs 104 may support a single frame structure. In some other implementations, such as in 5G and among other suitable radio access technologies, the NEs 102 and the UEs 104 may support various frame structures (i.e., multiple frame structures). The NEs 102 and the UEs 104 may support various frame structures based on one or more numerologies.

One or more numerologies may be supported in the wireless communications system 100, and a numerology may include a subcarrier spacing and a cyclic prefix. A first numerology (e.g., μ=0) may be associated with a first subcarrier spacing (e.g., 15 kHz) and a normal cyclic prefix. In some implementations, the first numerology (e.g., μ=0) associated with the first subcarrier spacing (e.g., 15 kHz) may utilize one slot per subframe. A second numerology (e.g., μ=1) may be associated with a second subcarrier spacing (e.g., 30 kHz) and a normal cyclic prefix. A third numerology (e.g., μ=2) may be associated with a third subcarrier spacing (e.g., 60 kHz) and a normal cyclic prefix or an extended cyclic prefix. A fourth numerology (e.g., μ=3) may be associated with a fourth subcarrier spacing (e.g., 120 kHz) and a normal cyclic prefix. A fifth numerology (e.g., μ=4) may be associated with a fifth subcarrier spacing (e.g., 240 kHz) and a normal cyclic prefix.

A time interval of a resource (e.g., a communication resource) may be organized according to frames (also referred to as radio frames). Each frame may have a duration, for example, a 10 millisecond (ms) duration. In some implementations, each frame may include multiple subframes. For example, each frame may include 10 subframes, and each subframe may have a duration, for example, a 1 ms duration. In some implementations, each frame may have the same duration. In some implementations, each subframe of a frame may have the same duration.

Additionally, or alternatively, a time interval of a resource (e.g., a communication resource) may be organized according to slots. For example, a subframe may include a number (e.g., quantity) of slots. The number of slots in each subframe may also depend on the one or more numerologies supported in the wireless communications system 100. For instance, the first, second, third, fourth, and fifth numerologies (i.e., μ=0, μ=1, μ=2, μ=3, μ=4) associated with respective subcarrier spacings of 15 kHz, 30 kHz, 60 kHz, 120 kHz, and 240 kHz may utilize a single slot per subframe, two slots per subframe, four slots per subframe, eight slots per subframe, and 16 slots per subframe, respectively. Each slot may include a number (e.g., quantity) of symbols (e.g., OFDM symbols). In some implementations, the number (e.g., quantity) of slots for a subframe may depend on a numerology. For a normal cyclic prefix, a slot may include 14 symbols. For an extended cyclic prefix (e.g., applicable for 60 kHz subcarrier spacing), a slot may include 12 symbols. The relationship between the number of symbols per slot, the number of slots per subframe, and the number of slots per frame for a normal cyclic prefix and an extended cyclic prefix may depend on a numerology. It should be understood that reference to a first numerology (e.g., μ=0) associated with a first subcarrier spacing (e.g., 15 kHz) may be used interchangeably between subframes and slots.

In the wireless communications system 100, an electromagnetic (EM) spectrum may be split, based on frequency or wavelength, into various classes, frequency bands, frequency channels, etc. By way of example, the wireless communications system 100 may support one or multiple operating frequency bands, such as frequency range designations FR1 (410 MHz-7.125 GHz), FR2 (24.25 GHz-52.6 GHz), FR3 (7.125 GHz-24.25 GHz), FR4 (52.6 GHz-114.25 GHz), FR4a or FR4-1 (52.6 GHz-71 GHz), and FR5 (114.25 GHz-300 GHz). In some implementations, the NEs 102 and the UEs 104 may perform wireless communications over one or more of the operating frequency bands. In some implementations, FR1 may be used by the NEs 102 and the UEs 104, among other equipment or devices for cellular communications traffic (e.g., control information, data). In some implementations, FR2 may be used by the NEs 102 and the UEs 104, among other equipment or devices for short-range, high data rate capabilities.

FR1 may be associated with one or multiple numerologies (e.g., at least three numerologies). For example, FR1 may be associated with a first numerology (e.g., μ=0), which includes 15 kHz subcarrier spacing; a second numerology (e.g., μ=1), which includes 30 kHz subcarrier spacing; and a third numerology (e.g., μ=2), which includes 60 kHz subcarrier spacing. FR2 may be associated with one or multiple numerologies (e.g., at least 2 numerologies). For example, FR2 may be associated with a third numerology (e.g., μ=2), which includes 60 kHz subcarrier spacing; and a fourth numerology (e.g., μ=3), which includes 120 kHz subcarrier spacing.

As described herein, in some embodiments, a new or enhanced SSB design or structure enables the use of XL MIMO configurations by a cell or cell area of a network, such as a cell area associated with the NE 102. The number of SSBs covering a cell area in an XL MIMO configuration may be based on a large antenna array size (e.g., 1024 antenna elements). The large antenna array size may also introduce farfield, nearfield, and/or frequency dependent/beam squinting effects, along with carrier bandwidths in the 7 to 24 GHz spectrum and/or a mmWave spectrum (e.g., above 28 GHz).

The number of SSB transmissions, such as 128 or 256 SSB beams using a beam sweeping technique in a time and/or frequency domain, is based on the XL MIMO configuration (e.g., 128/256 TxRUs and 512/1024 antenna elements) and increases the SSB transmission duration for the SSB transmissions.

In some cases, not all frequency ranges support an XL MIMO configuration. For example, with higher frequencies the wavelength decreases, and distances (e.g., the lambda/2 distance) between antenna element decreases, which facilitates adding additional antenna elements within a smaller space. However, the increase in the frequency range increases the path loss, and more antenna elements are used to compensate for the increased pathloss. Thus, the use of more antenna elements at higher frequency ranges results in more SSB beams to cover a cell area, with respect to lower frequency ranges. For example, the number of SSB beams for frequencies less than 3 GHz is 4, while the number of SSB beams for frequencies between 3 GHz and 6 GHz is 8 and so on.

The SSB burst size (or SB burst duration) can be configured to accommodate a number of SSB transmission the within SSB burst duration, which varies across frequency ranges. Thus, the SSB burst size may be based on varying numbers or quantities of SSBs for different frequency ranges of a cell, reducing the latency of the SSB duration.

In some embodiments, the SSB burst size or burst duration is based on (or predefined) a combination of a frequency range for a cell, SCSs, and/or a maximum number of supported candidate beams (e.g., using an N number of TxRUs or antenna elements for the frequency range). For example, given a frequency range between 3 GHz and 6 GHz, using a 15 kHz or 30 kHz SCS, 8 SSB beams can be configured with an SSB burst size of 3 ms. As another example, given a frequency range between 6 GHz to 24 GHz, using a 60 or 120 kHz SCS, 64 or 128 or 256 SSB beams can be configured with a SSB burst size of more than 5 ms, such as 10 ms, 20 ms, 30 ms, and so on. Thus, a defined, or predefined SSB burst size, can be based on the frequency range and the number of SSBs.

In some embodiments, a cell (e.g., the NE 102) may employ various techniques or SSB designs when support large numbers of SSB beams (e.g., 64 or 128 or 256 SSB beams for an XL MIMO configuration having 128/256 TxRUs and 512/1024 antenna elements.

For example, the cell may be configured to transmit a single, contiguous SSB burst size or burst duration, transmitting 64 or 128 or 256 SSB beams using a beam sweeping technique in the time and/or frequency domain. The SSB burst size or duration of an SSB burst or discovery burst transmission duration may be up to 10 or 20 or 30 milliseconds, based on the number of SSB blocks mapped in a slot.

As an example, given a 60 kHz SCS, 128 SSBs, and 2 SSBs mapped per slot, the SSB burst size or duration may be approximately 16 ms, while the SSB burst size or duration when 3 SSBs are mapped per slot may be approximately 11 ms. As another example, given a 60 kHz SCS, 256 SSBs, and 2 SSBs mapped per slot, the SSB burst size or duration may be approximately 32 ms, while the SSB burst size or duration when 3 SSBs are mapped per slot may be approximately 22 ms. Thus, the cell can support a large number of SSB beam transmissions by transmitting the SSB beams contiguously in time and increasing the SSB burst size or duration by 4 to 7 times (from 5 ms to 20-35 ms), depending on the frequency range, the SCS, and/or the maximum number of candidate SSB beams supported by the cell.

In some cases, a contiguous SSB burst, sweeping an entire coverage area of a cell, can be contiguously mapped within 2 to 4 radio frames, and the contiguous SSB burst transmissions can be within the first 2 to 4 radio frames or the last 2 to 4 radio frames, within a 5 radio frame boundary (e.g., 50 ms). The cell (e.g., the NE 102) may indicate the configuration via a MIB or other information blocks. The cell (e.g., the NE 102) may configure a maximum discovery burst transmission time (e.g., a SSB transmission time) based on an associated frequency range, SCS, and so on.

In some embodiments, the cell (e.g., the NE 102) may utilize 12 symbols of a slot when mapping 3 SSBs in the slot (e.g., each of the SSBs occupying 4 symbols). However, when utilizing time-division multiplexing for the SSBs and a CORESET (e.g., CORESET#0), the cell (e.g., the NE 102) may allocate one or two initial symbols, or middle symbols, to the CORESET and map the 3 SSBs to symbols proximate to the initial symbols. In some cases, because the mapping between SSBs and the CORESET is applicable for various frequency ranges and/or SCSs, a maximum of two symbols may be allocated to the CORESET for the 3 SSBs.

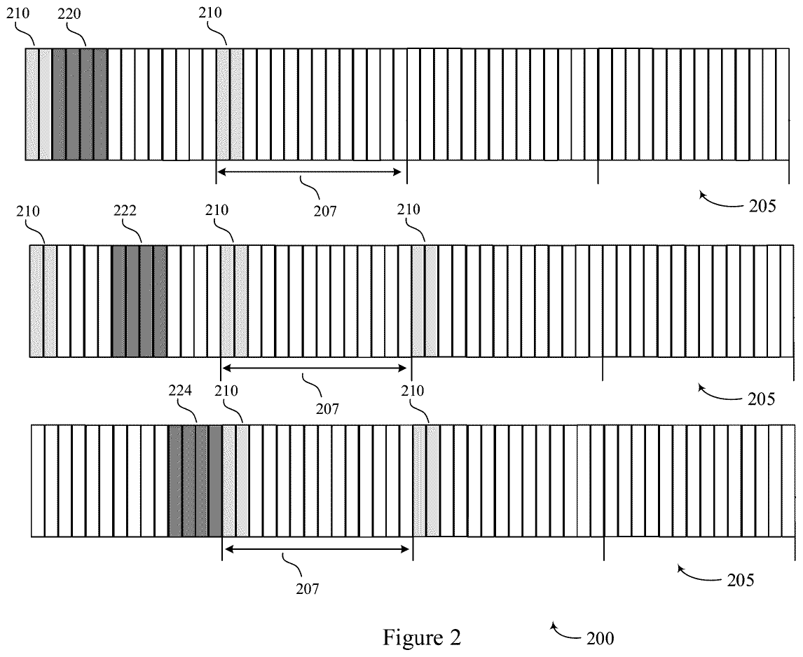

FIG. 2 illustrates an example mapping 200 between SSBs and a CORESET in accordance with aspects of the present disclosure. A radio frame 205 (e.g., a portion of a radio frame showing 5 slots 207) allocates two symbols to a CORESET#0 at a beginning of the slot 207 and allocates 3 SSBs to the remaining 12 symbols of the slot 207. For example, the slot 207 includes a CORESET#0 210 in the first two OFDM symbols, a first SSB index 220 in the next 4 OFDM symbols, a second SSB index 222 in the next 4 OFDM symbols, and a third SSB index 224 in the last 4 OFDM symbols of the slot 207.

Thus, the first SSB index 220 and the second SSB index 222 of the slot 207 may be associated with the CORESET#0 210 in the first two symbols of the same slot, and in a next slot (N+1), while the third SSB index 224 transmitted in the slot 207 may be associated with the CORESET#0 210 transmitted in the slot N+1 and a slot N+2.

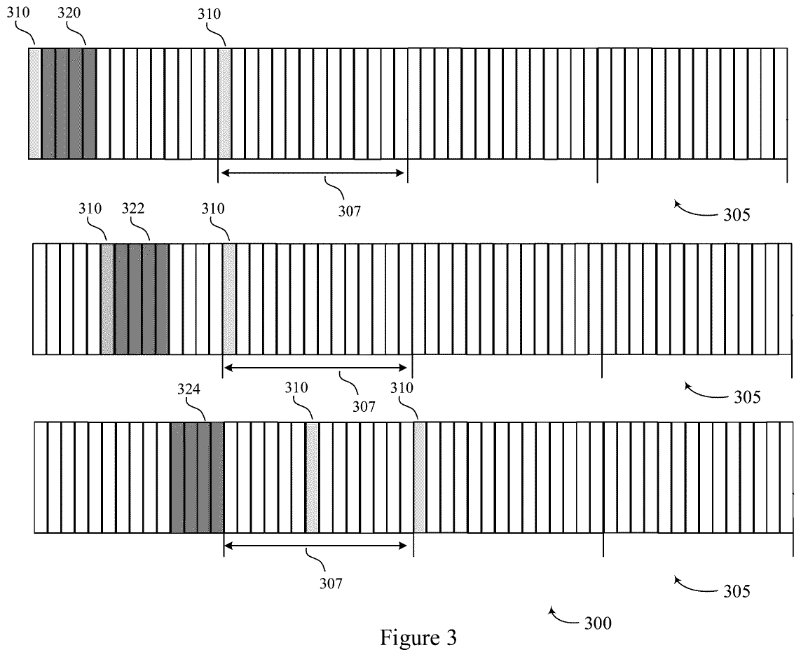

FIG. 3 illustrates another example mapping 300 between SSBs and a CORESET in accordance with aspects of the present disclosure. A radio frame 305 (e.g., a portion of a radio frame showing 5 slots 307) allocates one symbol to a CORESET#0 at a beginning of the slot 307 and allocates another symbol in the middle of the slot 2307 to the CORESET#0 (e.g., for a two symbol CORESET). Thus, the mapping 300 includes a one symbol CORESET#0 between a first SSB index 320 and a second SSB index 222, resulting in a non-contiguous SSB mapping of the SSBs.

For example, the first SSB index 320 may be mapped to the CORESET#0 310 transmitted at the beginning of a slot N and a slot N+, the second SSB index 322 may be mapped to the CORESET#0 symbol 310 transmitted in the middle of slot N and the beginning of slot N+1, and a third SSB index 324 may be mapped to a CORESET#0 310 transmitted in the middle of slot N+1 and a beginning of slot N+2. It is to be understood that the mappings 200, 300 between the SSBs and the CORESET#0 depict example mappings, and that the cell (e.g., the NE 102) may utilize various methods to determine/allocate the positions of the SSBs and CORESET#0 within slots of a radio frame.

In some embodiments, the cell (e.g., the NE 102) may be configured to transmit multiple SSB bursts within an SSB burst size or duration (e.g., a shorter SSB burst), where each of the multiple SSB bursts covers a portion of part of a cell area. For example, the cell (e.g., the NE 102) may segment the SSBs into smaller SSB burst size (e.g., 3 ms or 5 ms). The cell may insert a time gap between adjacent SSB bursts (e.g., the smaller SSB bursts or SSB burst segments), which can be determined based on transmission over various frequency ranges and SCSs (e.g., if smaller SSB bursts (e.g., all smaller SSB bursts) are within a configured SSB transmission burst duration).

In some cases, the time gap, which is a time between adjacent SSB bursts transmitted non-contiguously within the total SSB bursts duration (e.g., discovery bursts duration), may be based on a frequency range for the cell area, the SCS, and/or a maximum number of candidate SSB beams that correspond to an XL MIMO configuration (e.g., a number of TXRUs and/or number of antenna elements for the cell area). The time gap may be in msec or a quantity of slots or symbols, such as symbols defined from a last OFDM symbol of SSBs or CORESET#0 of a first SSB burst to a first OFDM symbol of an SSB of a second SSB burst. In some cases, the time gap is based on the SCS, the frequency range, and so on.

In some embodiments, the cell (e.g., the NE 102) may support a large number (e.g., 128 or 256) of SSB beam transmissions by segmenting the large number of SSB beams in a time domain and non-contiguously transmitting each smaller (e.g., segmented) SSB bursts, which each have a size or duration of 5 ms (or less).

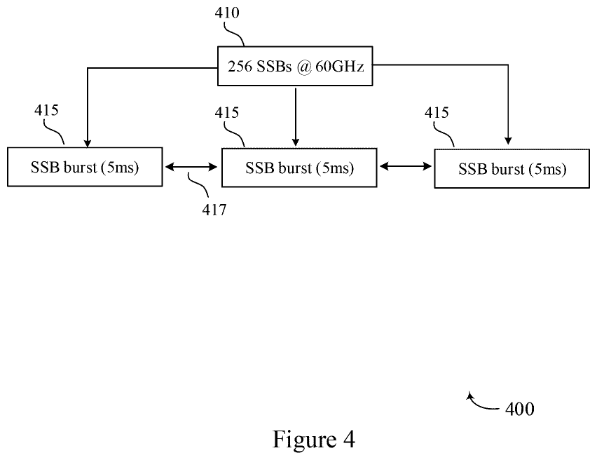

FIG. 4 illustrates an example of a non-contiguous SSB transmission 400 in accordance with aspects of the present disclosure. A cell (e.g., the NE 102) transmit 256 SSBs (@60 GHz) 410 via multiple SSB bursts 415, where the SSB burst size or duration is 5 ms, and where a time gap 417 is inserted between adjacent SSB bursts 415. As described herein, each small or segmented SSB burst 415 may cover a part or portion of the coverage area of the cell area. Also, when the time gap 417 between consecutive SSB bursts 415 is set to zero, the SSB transmission 410 may perform as a contiguous SSB transmission (as described herein).

In some cases, because 256 SSB beams may utilize multiple half radio frames, a mapping of the SSB bursts to a number of radio frames may be non-contiguous, where the number of radio frames for transmitting the multiple segmented SSB bursts, covering an entire cell area, may be relatively longer (e.g., 40-50 ms).

In some embodiments, a cell (e.g., the NE 102) may be configured to perform a partial transmission of SSBs within one or more SSB bursts in a contiguous or non-contiguous manner. For example, the cell may perform one or more SSB transmissions (e.g., partial SSB transmission) via a first SSB transmission burst duration and a second SSB transmission burst duration. In some cases, each SSB transmission burst duration may have a defined value that is based on the frequency range for the cell, the SCS, and/or a number of candidate SSBs according to a corresponding XL MIMO configuration. Thus, the cell may select a subset of SSBs to be transmitted in a first SSB transmission burst duration and select remaining SSBs to be transmitted in a second SSB transmission burst duration.

For example, the cell may select an odd SSB index (e.g., an SSB index #1 or #2) to be transmitted in a first SSB burst transmission duration and select an even SSB index (e.g., an SSB index #2) to be transmitted in a second SSB burst transmission. As another example, the cell may select a first half of a set of SSBs (e.g., one or more SSBs), covering a partial cell area, to be transmitted in the first SSB transmission burst duration, and select a remaining half of the set of SSBs, covering the rest of the cell area, to be transmitted in the second SSB transmission burst duration. Thus, the cell may divide or segment a total number of SSBs according to the number of SSBs transmitted in a transmission burst duration, the number of transmission burst durations, and so on.

In some embodiments, the cell (e.g., the NE 102) may indicate an SSB transmission pattern having a non-contiguous or interleaved pattern within the SSB transmission burst duration (e.g., a discovery burst duration) via an additional information element of a system information block (e.g., SIB-1). For example, the cell may include a field or information element (IE) that indicates an “SSB burst position” within an SIB-1 transmitted to UEs served by the cell.

The IE may signal a candidate SSB burst index transmission from a total SSB transmission burst duration by grouping and/or indexing the SSBs within an SSB burst using a group presence. The IE may indicate an SSB position in the group to identify an SSB block index within a group. For example, the cell, via bitmap signaling, may indicate an SSB transmission patterns as follows:
SSB burst within SSB burst sets→SSB group within each SSB burst→SSB block within each SSB group.

In some cases, the cell may indicate multiple group presence and SSB burst positions corresponding to an SSB burst position, which may enable flexible selection and transmission of SSBs within each SSB burst size or duration.

In some embodiments, a mapping of SSBs to a RACH procedure (e.g., to RACH occasions) may be based on an SSB burst position index, in addition to an SSB block index, because each SSB burst partially covers a cell area. A physical RACH (PRACH) configuration index determines a RACH occasion in the time domain and Msg-FDM determines the number of RACH resources in the frequency at each time instance. Further, a parameter ssb-perRACH-OccasionAndCB-PreamblesPerSSB determines an SSB block to RACH resource mapping. The cell, therefore, may configure a mapping of the SSB burst index to RACH occasion set mapping and signal the mapping via the SIB.

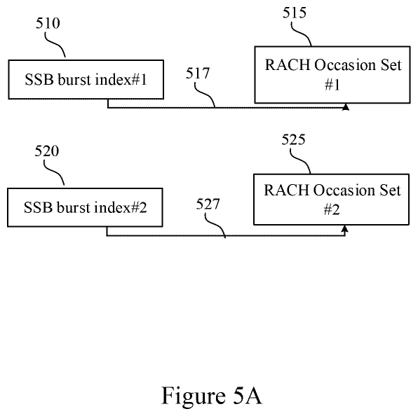

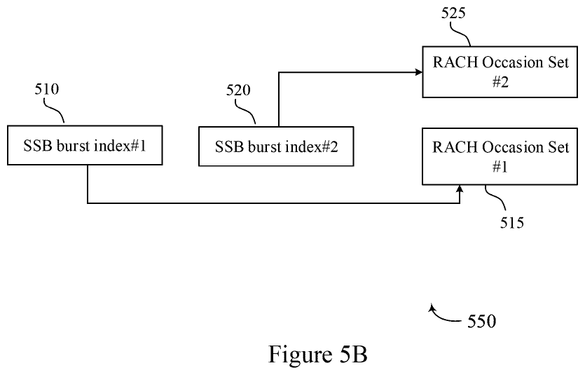

FIGS. 5A-5B illustrate example mappings of SSB bursts to RACH occasions in accordance with aspects of the present disclosure. FIG. 5A depicts a mapping 517 between a first SSB burst index 510 and a first RACH occasion set 515 and a mapping 527 between a second SSB burst index 520 and a second RACH occasion set 525. In some cases, the RACH occasion sets 515 and 525, or RACH resource occasion sets, are defined and mapped for each SSB burst index 510 and 620 within a total SSB transmission burst duration by having a time duration offset between an SSB burst and a corresponding, or mapped, RACH occasion set. Further, SSB blocks within each SSB burst are mapped to separate RACH occasions within each RACH occasion set.

FIG. 5B depicts a frequency-division multiplexed mapping 550 between the SSB burst indexes 510 and 520, and the RACH occasion sets 515 and 525. The frequency-division multiplexed mapping 550 includes an ascending order of FDM-ed RACH occasion sets mapped to an ascending order of SSB burst indexes, within a total SSB transmission burst duration.

In some embodiments, the cell (e.g., the NE 102) can configure or implement a code division multiplexed mapping between the SSB burst indexes and RACH occasion sets, where each RACH occasion set is CDM-ed in time and frequency resources and associated with an SSB burst index. In some cases, the cell may configure a maximum time for an SSB burst, and RACH occasions within the maximum time can be allowed for RACH resource selection for the SSB burst, while RACH occasions outside of the maximum time may not be used for RACH transmissions by a UE (e.g., the UE 104). Thus, the UE can select RACH resources outside of the maximum time for a subsequent SSB burst and can calculate a time from a last slot of an SSB block that was transmitted in an SSB burst. Further, all SSBs of SSB burst sets that form a total SSB transmission burst duration covering a cell coverage area are mapped or associated with at least one RACH occasion.

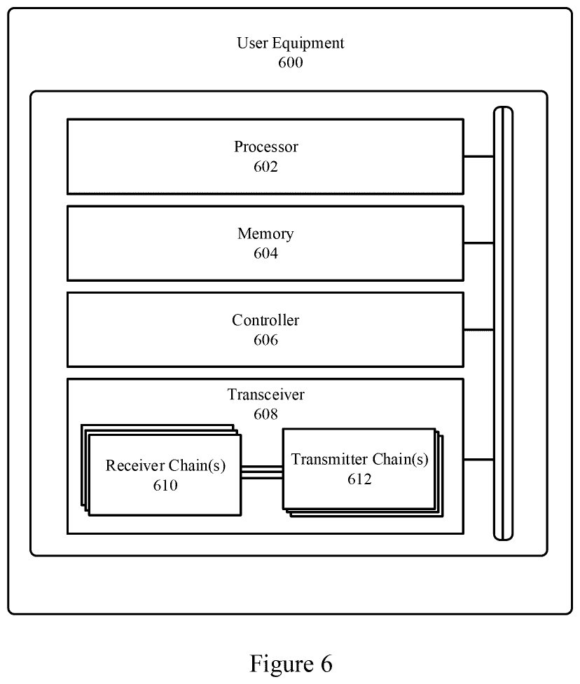

FIG. 6 illustrates an example of a UE 600 in accordance with aspects of the present disclosure. The UE 600 may include a processor 602, a memory 604, a controller 606, and a transceiver 608. The processor 602, the memory 604, the controller 606, or the transceiver 608, or various combinations thereof or various components thereof may be examples of means for performing various aspects of the present disclosure as described herein. These components may be coupled (e.g., operatively, communicatively, functionally, electronically, electrically) via one or more interfaces.

The processor 602, the memory 604, the controller 606, or the transceiver 608, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 602 may include an intelligent hardware device (e.g., a general-purpose processor, a DSP, a CPU, an ASIC, an FPGA, or any combination thereof). In some implementations, the processor 602 may be configured to operate the memory 604. In some other implementations, the memory 604 may be integrated into the processor 602. The processor 602 may be configured to execute computer-readable instructions stored in the memory 604 to cause the UE 600 to perform various functions of the present disclosure.

The memory 604 may include volatile or non-volatile memory. The memory 604 may store computer-readable, computer-executable code including instructions when executed by the processor 602 cause the UE 600 to perform various functions described herein. The code may be stored in a non-transitory computer-readable medium such the memory 604 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 602 and the memory 604 coupled with the processor 602 may be configured to cause the UE 600 to perform one or more of the functions described herein (e.g., executing, by the processor 602, instructions stored in the memory 604). For example, the processor 602 may support wireless communication at the UE 600 in accordance with examples as disclosed herein.

The controller 606 may manage input and output signals for the UE 600. The controller 606 may also manage peripherals not integrated into the UE 600. In some implementations, the controller 606 may utilize an operating system such as iOS®, ANDROID®, WINDOWS®, or other operating systems. In some implementations, the controller 606 may be implemented as part of the processor 602.

In some implementations, the UE 600 may include at least one transceiver 608. In some other implementations, the UE 600 may have more than one transceiver 608. The transceiver 608 may represent a wireless transceiver. The transceiver 608 may include one or more receiver chains 610, one or more transmitter chains 612, or a combination thereof.

A receiver chain 610 may be configured to receive signals (e.g., control information, data, packets) over a wireless medium. For example, the receiver chain 610 may include one or more antennas for receive the signal over the air or wireless medium. The receiver chain 610 may include at least one amplifier (e.g., a low-noise amplifier (LNA)) configured to amplify the received signal. The receiver chain 610 may include at least one demodulator configured to demodulate the receive signal and obtain the transmitted data by reversing the modulation technique applied during transmission of the signal. The receiver chain 610 may include at least one decoder for decoding the processing the demodulated signal to receive the transmitted data.

A transmitter chain 612 may be configured to generate and transmit signals (e.g., control information, data, packets). The transmitter chain 612 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmitter chain 612 may also include at least one power amplifier configured to amplify the modulated signal to an appropriate power level suitable for transmission over the wireless medium. The transmitter chain 612 may also include one or more antennas for transmitting the amplified signal into the air or wireless medium.

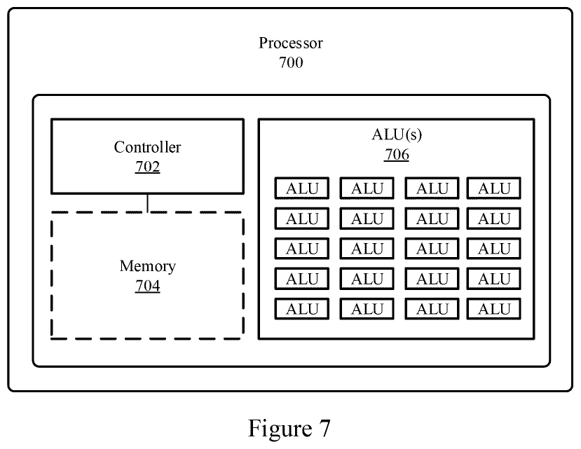

FIG. 7 illustrates an example of a processor 700 in accordance with aspects of the present disclosure. The processor 700 may be an example of a processor configured to perform various operations in accordance with examples as described herein. The processor 700 may include a controller 702 configured to perform various operations in accordance with examples as described herein. The processor 700 may optionally include at least one memory 704, which may be, for example, an L1/L2/L3 cache. Additionally, or alternatively, the processor 700 may optionally include one or more arithmetic-logic units (ALUs) 706. One or more of these components may be in electronic communication or otherwise coupled (e.g., operatively, communicatively, functionally, electronically, electrically) via one or more interfaces (e.g., buses).

The processor 700 may be a processor chipset and include a protocol stack (e.g., a software stack) executed by the processor chipset to perform various operations (e.g., receiving, obtaining, retrieving, transmitting, outputting, forwarding, storing, determining, identifying, accessing, writing, reading) in accordance with examples as described herein. The processor chipset may include one or more cores, one or more caches (e.g., memory local to or included in the processor chipset (e.g., the processor 700) or other memory (e.g., random access memory (RAM), read-only memory (ROM), dynamic RAM (DRAM), synchronous dynamic RAM (SDRAM), static RAM (SRAM), ferroelectric RAM (FeRAM), magnetic RAM (MRAM), resistive RAM (RRAM), flash memory, phase change memory (PCM), and others).

The controller 702 may be configured to manage and coordinate various operations (e.g., signaling, receiving, obtaining, retrieving, transmitting, outputting, forwarding, storing, determining, identifying, accessing, writing, reading) of the processor 700 to cause the processor 700 to support various operations in accordance with examples as described herein. For example, the controller 702 may operate as a control unit of the processor 700, generating control signals that manage the operation of various components of the processor 700. These control signals include enabling or disabling functional units, selecting data paths, initiating memory access, and coordinating timing of operations.

The controller 702 may be configured to fetch (e.g., obtain, retrieve, receive) instructions from the memory 704 and determine subsequent instruction(s) to be executed to cause the processor 700 to support various operations in accordance with examples as described herein. The controller 702 may be configured to track memory address of instructions associated with the memory 704. The controller 702 may be configured to decode instructions to determine the operation to be performed and the operands involved. For example, the controller 702 may be configured to interpret the instruction and determine control signals to be output to other components of the processor 700 to cause the processor 700 to support various operations in accordance with examples as described herein. Additionally, or alternatively, the controller 702 may be configured to manage flow of data within the processor 700. The controller 702 may be configured to control transfer of data between registers, arithmetic logic units (ALUs), and other functional units of the processor 700.

The memory 704 may include one or more caches (e.g., memory local to or included in the processor 700 or other memory, such RAM, ROM, DRAM, SDRAM, SRAM, MRAM, flash memory, etc. In some implementations, the memory 704 may reside within or on a processor chipset (e.g., local to the processor 700). In some other implementations, the memory 704 may reside external to the processor chipset (e.g., remote to the processor 700).

The memory 704 may store computer-readable, computer-executable code including instructions that, when executed by the processor 700, cause the processor 700 to perform various functions described herein. The code may be stored in a non-transitory computer-readable medium such as system memory or another type of memory. The controller 702 and/or the processor 700 may be configured to execute computer-readable instructions stored in the memory 704 to cause the processor 700 to perform various functions. For example, the processor 700 and/or the controller 702 may be coupled with or to the memory 704, the processor 700, the controller 702, and the memory 704 may be configured to perform various functions described herein. In some examples, the processor 700 may include multiple processors and the memory 704 may include multiple memories. One or more of the multiple processors may be coupled with one or more of the multiple memories, which may, individually or collectively, be configured to perform various functions herein.

The one or more ALUs 706 may be configured to support various operations in accordance with examples as described herein. In some implementations, the one or more ALUs 706 may reside within or on a processor chipset (e.g., the processor 700). In some other implementations, the one or more ALUs 706 may reside external to the processor chipset (e.g., the processor 700). One or more ALUs 706 may perform one or more computations such as addition, subtraction, multiplication, and division on data. For example, one or more ALUs 706 may receive input operands and an operation code, which determines an operation to be executed. One or more ALUs 706 be configured with a variety of logical and arithmetic circuits, including adders, subtractors, shifters, and logic gates, to process and manipulate the data according to the operation. Additionally, or alternatively, the one or more ALUs 706 may support logical operations such as AND, OR, exclusive-OR (XOR), not-OR (NOR), and not-AND (NAND), enabling the one or more ALUs 706 to handle conditional operations, comparisons, and bitwise operations.

The processor 700 may support wireless communication in accordance with examples as disclosed herein.

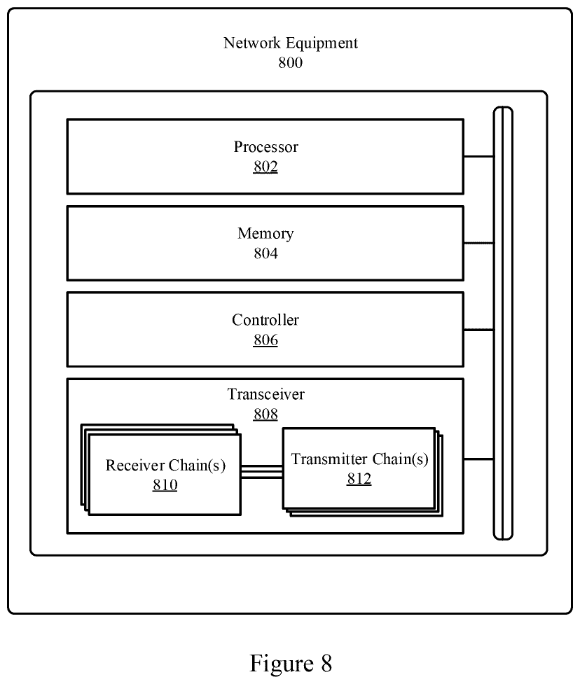

FIG. 8 illustrates an example of a NE 800 in accordance with aspects of the present disclosure. The NE 800 may include a processor 802, a memory 804, a controller 806, and a transceiver 808. The processor 802, the memory 804, the controller 806, or the transceiver 808, or various combinations thereof or various components thereof may be examples of means for performing various aspects of the present disclosure as described herein. These components may be coupled (e.g., operatively, communicatively, functionally, electronically, electrically) via one or more interfaces.

The processor 802, the memory 804, the controller 806, or the transceiver 808, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 802 may include an intelligent hardware device (e.g., a general-purpose processor, a DSP, a CPU, an ASIC, an FPGA, or any combination thereof). In some implementations, the processor 802 may be configured to operate the memory 804. In some other implementations, the memory 804 may be integrated into the processor 802. The processor 802 may be configured to execute computer-readable instructions stored in the memory 804 to cause the NE 800 to perform various functions of the present disclosure.

The memory 804 may include volatile or non-volatile memory. The memory 804 may store computer-readable, computer-executable code including instructions when executed by the processor 802 cause the NE 800 to perform various functions described herein. The code may be stored in a non-transitory computer-readable medium such the memory 804 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 802 and the memory 804 coupled with the processor 802 may be configured to cause the NE 800 to perform one or more of the functions described herein (e.g., executing, by the processor 802, instructions stored in the memory 804).

For example, the processor 802 may support wireless communication at the NE 800 in accordance with examples as disclosed herein. The NE 800 may be configured to support a means for configuring multiple SSB burst size values based on a frequency range for a cell area, SCSs for the cell area, and a maximum number of supported SSB beams based on an XL MIMO configuration of an antenna array for the cell area, and transmitting a number of SSBs covering the cell area within an SSB burst transmission duration that is based on the configured multiple SSB burst size values.

As another example, the NE 800 may be configured to support a means for mapping an SSB burst index to a RACH occasion set and signaling the mapping to one or more UEs within a cell area.

The controller 806 may manage input and output signals for the NE 800. The controller 806 may also manage peripherals not integrated into the NE 800. In some implementations, the controller 806 may utilize an operating system such as iOS®, ANDROID®, WINDOWS®, or other operating systems. In some implementations, the controller 806 may be implemented as part of the processor 802.

In some implementations, the NE 800 may include at least one transceiver 808. In some other implementations, the NE 800 may have more than one transceiver 808. The transceiver 808 may represent a wireless transceiver. The transceiver 808 may include one or more receiver chains 810, one or more transmitter chains 812, or a combination thereof.

A receiver chain 810 may be configured to receive signals (e.g., control information, data, packets) over a wireless medium. For example, the receiver chain 810 may include one or more antennas for receive the signal over the air or wireless medium. The receiver chain 810 may include at least one amplifier (e.g., a low-noise amplifier (LNA)) configured to amplify the received signal. The receiver chain 810 may include at least one demodulator configured to demodulate the receive signal and obtain the transmitted data by reversing the modulation technique applied during transmission of the signal. The receiver chain 810 may include at least one decoder for decoding the processing the demodulated signal to receive the transmitted data.

A transmitter chain 812 may be configured to generate and transmit signals (e.g., control information, data, packets). The transmitter chain 812 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmitter chain 812 may also include at least one power amplifier configured to amplify the modulated signal to an appropriate power level suitable for transmission over the wireless medium. The transmitter chain 812 may also include one or more antennas for transmitting the amplified signal into the air or wireless medium.

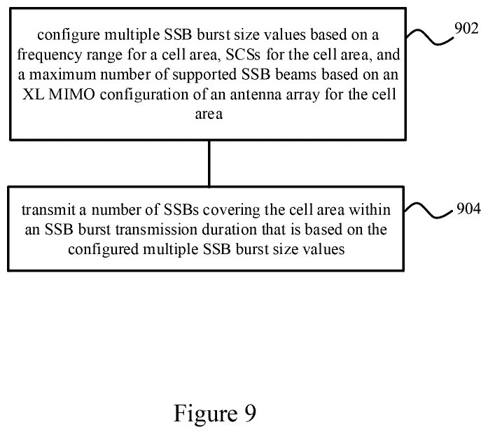

FIG. 9 illustrates a flowchart of a method in accordance with aspects of the present disclosure. The operations of the method may be implemented by an NE as described herein. In some implementations, the NE may execute a set of instructions to control the function elements of the NE to perform the described functions.

At 902, the method may include configuring multiple SSB burst size values based on a frequency range for a cell area, SCSs for the cell area, and a maximum number of supported SSB beams based on an XL MIMO configuration of an antenna array for the cell area. The operations of 902 may be performed in accordance with examples as described herein. In some implementations, aspects of the operations of 902 may be performed by an NE as described with reference to FIG. 8.

At 904, the method may include transmitting a number of SSBs covering the cell area within an SSB burst transmission duration that is based on the configured multiple SSB burst size values. The operations of 904 may be performed in accordance with examples as described herein. In some implementations, aspects of the operations of 904 may be performed by an NE as described with reference to FIG. 8.

It should be noted that the method described herein describes a possible implementation, and that the operations and the steps may be rearranged or otherwise modified and that other implementations are possible.

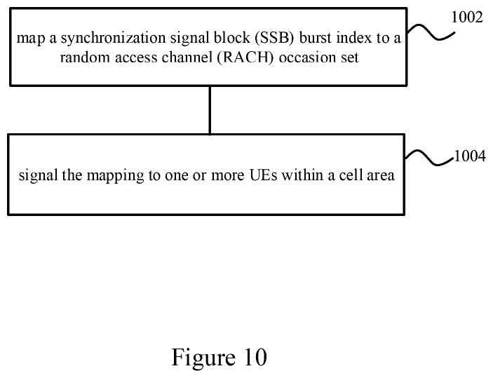

FIG. 10 illustrates a flowchart of a method in accordance with aspects of the present disclosure. The operations of the method may be implemented by an NE as described herein. In some implementations, the NE may execute a set of instructions to control the function elements of the NE to perform the described functions.

At 1002, the method may include mapping an SSB burst index to a RACH occasion set. The operations of 1002 may be performed in accordance with examples as described herein. In some implementations, aspects of the operations of 1002 may be performed by an NE as described with reference to FIG. 8.

At 1004, the method may include signaling the mapping to one or more UEs within a cell area. The operations of 1004 may be performed in accordance with examples as described herein. In some implementations, aspects of the operations of 1004 may be performed by an NE as described with reference to FIG. 8.

It should be noted that the method described herein describes a possible implementation, and that the operations and the steps may be rearranged or otherwise modified and that other implementations are possible.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A network entity for wireless communication, comprising:
at least one memory; and
at least one processor coupled with the at least one memory and configured to cause the network entity to:
configure multiple synchronization signal block (SSB) burst size values based on a frequency range for a cell area, subcarrier spacings (SCSs) for the cell area, and a maximum number of supported SSB beams based on an extremely large-scale multiple-input-multiple-output (XL MIMO) configuration of an antenna array for the cell area; and
transmit a number of SSBs covering the cell area within an SSB burst transmission duration that is based on the configured multiple SSB burst size values.

2. The network entity of claim 1, wherein the maximum number of supported SSB beams is based on a number of antenna elements within the XL MIMO configuration of the cell area.

3. The network entity of claim 1, wherein the at least one processor is configured to cause the network entity to:
segment the SSB burst transmission duration with multiple SSB bursts associated with the multiple SSB burst size values;
insert a time gap between adjacent SSB bursts of the multiple SSB bursts; and
transmit the number of SSBs covering the cell area using the multiple SSB bursts.

4. The network entity of claim 1, wherein the at least one processor is configured to cause the network entity to transmit the number of SSBs contiguously via beam sweeping over the cell area based on the configured multiple SSB burst size values.

5. The network entity of claim 4, wherein the at least one processor is further configured to cause the network entity to:
transmit a master information block (MIB) indicating multiple radio frames that map the number of SSBs.

6. The network entity of claim 1, wherein the at least one processor is configured to cause the network entity to transmit the number of SSBs within symbols of a slot of a radio frame located after a control resource set (CORESET) allocated to an initial symbol of the slot.

7. The network entity of claim 1, wherein the at least one processor is configured to cause the network entity to transmit the number of SSBs within symbols of a slot of a radio frame located after a control resource set (CORESET) allocated to two initial symbols of the slot.

8. The network entity of claim 1, wherein the at least one processor is further configured to cause the network entity to transmit the number of SSBs based on the configured multiple SSB burst size values, by:
segmenting the SSB burst transmission duration into smaller SSB burst sizes; and
transmitting the number of SSBs via the smaller SSB burst sizes.

9. The network entity of claim 8, wherein the at least one processor is further configured to cause the network entity to:
segment the SSB burst transmission duration in a time domain; and
non-contiguously transmit the SSBs via the smaller SSB burst sizes.

10. The network entity of claim 8, wherein each of the smaller SSB burst sizes corresponds to a portion of the cell area.

11. The network entity of claim 8, wherein a quantity of the smaller SSB burst sizes is based on the frequency range for the cell area, the subcarrier spacings (SCSs) for the cell area, and the maximum number of supported SSB beams for the cell area.

12. The network entity of claim 1, wherein the at least one processor is further configured to cause the network entity to transmit a system information block (SIB) having an information element that indicates a candidate SSB burst index transmission for the configured multiple SSB burst size values.

13. A method performed by a network entity, the method comprising:
configuring multiple synchronization signal block (SSB) burst size values based on a frequency range for a cell area, subcarrier spacings (SCSs) for the cell area, and a maximum number of supported SSB beams based on an extremely large-scale multiple-input-multiple-output (XL MIMO) configuration of an antenna array for the cell area; and
transmitting a number of SSBs covering the cell area within an SSB burst transmission duration that is based on the configured multiple SSB burst size values.

14. The method of claim 13, wherein the maximum number of supported SSB beams is based on a number of antenna elements within the XL MIMO configuration of the cell area.

15. A network entity for wireless communication, comprising:
at least one memory; and
at least one processor coupled with the at least one memory and configured to cause the network entity to:
map a synchronization signal block (SSB) burst index to a random access channel (RACH) occasion set; and
signal the mapping to one or more user equipment (UEs) within a cell area.

16. The network entity of claim 15, wherein the mapping includes a mapping of SSB blocks within SSB bursts associated with the SSB burst index to RACH occasions of the RACH occasion set.

17. The network entity of claim 15, wherein the mapping includes a frequency division multiplexed mapping of an ascending order of RACH occasions of the RACH occasion set to an ascending order of SSB bursts associated with the SSB burst index.

18. The network entity of claim 15, wherein the mapping includes a mapping of SSB bursts associated with the SSB burst index and RACH occasions of the RACH occasion set that are code division multiplexed in time and frequency resources.

19. The network entity of claim 15, wherein the at least one processor is further configured to cause the network entity to assign a maximum time for selection of a RACH occasion mapped to a SSB burst associated with the SSB burst index.

20. A method performed by a network entity, the method comprising:
mapping a synchronization signal block (SSB) burst index to a random access channel (RACH) occasion set; and
signaling the mapping to one or more user equipment (UEs) within a cell area.
